(19) United States
(12) Patent Application Publication
(10) Pub. No.: US 2005/0224270 A1
(43) Pub. Date: Oct. 13, 2005

(54) Belt buckle presenter

(75) Inventors: Wolfgang Holbein, Alfdorf (DE); Wolf-Dieter Hoenl, Boebingen (DE); Andreas Baer, Augsburg (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive GmbH

(21) Appl. No.: 11/099,006

(22) Filed: Apr. 5, 2005

(30) Foreign Application Priority Data
Apr. 8, 2004 (DE) 10 2004 017 457.1

(51) Int. Cl. B60R 21/00

(52) U.S. Cl. 180/268

(57) ABSTRACT

A belt buckle presenter is capable of moving a belt buckle (32) by means of a drive between a lower initial position and an upper extension position. The belt buckle presenter comprises a blocking arrangement (22), the activation of the blocking arrangement (22) in a case of restraint preventing the belt buckle (32) from a movement upwards. The blocking arrangement (22) is also able to be activated in an intermediate position between the initial position and the extension position.

### BACKGROUND OF THE INVENTION

The invention relates to a belt buckle presenter capable of moving a belt buckle by means of a drive between a lower initial position and an upper extension position.

A belt buckle presenter serves to facilitate the fastening of the safety belt for a vehicle occupant. Generally, belt buckle presenters are known, which before fastening raise the belt buckle from a lower initial position into an upper extension position. This allows the occupant to insert the tongue of the safety belt into the belt buckle in a comfortable manner. After fastening, the belt buckle is lowered from the extension position into the initial position again, in which it remains during the ride. Before unfastening, the belt buckle is raised again, in order to also allow the occupant to release the tongue from the belt buckle in a comfortable manner, before it is then lowered again. In the initial position, the belt buckle is generally locked, so that in a case of restraint, in which the vehicle occupant wearing the belt is to be prevented by the safety belt from an abrupt forward movement, the belt buckle can not be moved upwards.

It is an object of the invention to provide a belt buckle presenter which offers to the vehicle occupant a protection which goes beyond the usual restraint effect of the safety belt with a lowered belt buckle.

### BRIEF SUMMARY OF THE INVENTION

The belt buckle presenter according to the invention is capable of moving a belt buckle by means of a drive between a lower initial position and an upper extension position, and comprises a blocking arrangement, activation of the blocking arrangement in a case of restraint preventing the belt buckle from a movement upwards, the blocking arrangement also being able to be activated in an intermediate position between the initial position and the extension position. The belt buckle presenter according to the invention thus ensures that the restraint function of the safety belt can already be taken up immediately after fastening, when the belt buckle is still being moved from the initial position into the extension position.

The blocking arrangement preferably includes a blocking element movable between a release position, in which a movement of the belt buckle is enabled, and a blocking position, in which a movement of the belt buckle is blocked.

The blocking element can comprise a locking pawl which is able to engage into a detent arrangement fixed to the vehicle or a vehicle seat. The detent arrangement can be formed by recesses spaced apart from each other, locking teeth or the like. Such blocking systems have proved to be successful in other devices for receiving the forces occurring in a case of restraint.

It proves to be advantageous that in the belt buckle presenter according to the invention, an end stop for the blocking arrangement is provided, the blocking arrangement being activated upon reaching the end stop. Thus, the belt buckle is also secured against tensile forces by the belt buckle presenter in the extension position.

### BRIEF DESCRIPTION OF THE DRAWINGS

FIG. 1 shows a sectional view of a belt buckle presenter according to the invention in the initial position;

FIGS. 2a, 2b show a transparent perspective and a lateral view of the blocking arrangement of the belt buckle presenter, respectively;

FIGS. 3a, 3b, 3c show the blocking arrangement in various phases of the blocking process in sectional view;

FIGS. 4a, 4b show a transparent perspective and a lateral view of the blocking arrangement shortly before or respectively in the extension position, respectively;

FIG. 5 shows the belt buckle presenter of FIG. 1 in an intermediate position;

FIG. 6 shows an illustration of the forces acting on the blocking arrangement in a case of restraint in an intermediate position of the belt buckle presenter;

FIG. 7 shows the belt buckle presenter of FIG. 1 in the blocked state in an intermediate position;

FIG. 8 shows a first alternative drive for the belt buckle presenter in sectional view;

FIG. 9 shows a belt buckle presenter with a second alternative drive in sectional view; and

FIGS. 10a, 10b show a transparent perspective and a lateral view of the blocking arrangement shortly before or in the extension position of the belt buckle presenter with an alternative end stop.

### DETAILED DESCRIPTION OF PREFERRED EMBODIMENTS

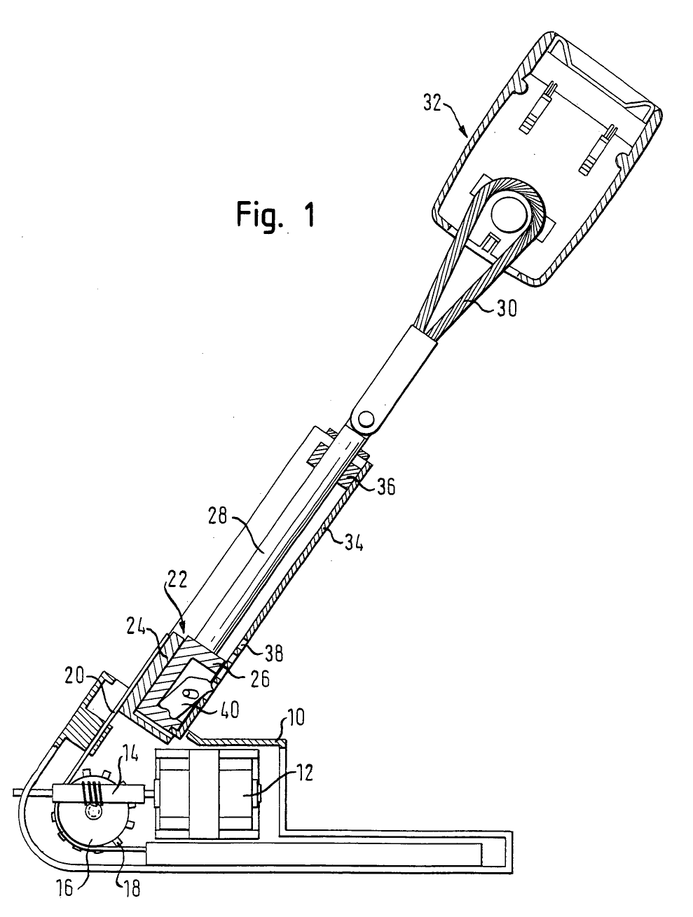

The belt buckle presenter illustrated in FIG. 1 comprises a drive housed in a housing 10 which is fixed to the vehicle or a vehicle seat. The drive comprises an electromotor 12 which can drive via a gear 14 a roller 16, which is mounted in the housing 10, in two directions of rotation. The roller 16 has radially projecting cams 18 distributed over its periphery, which engage into corresponding recesses of flexible conveyor belt 20 so that the drive movement of the roller 16 is transferred to the conveyor belt 20. The conveyor belt is deflected by means of the roller 16. The roller 16 can therefore be designated as both a deflection and a drive roller. The rigidity of the conveyor belt 20 is selected so that the components described below can be moved by the conveyor belt 20 in two opposite directions, i.e. pulled and pushed.

The conveyor belt 20 is connected with a first component 24 of a blocking arrangement 22, which is described later in further detail. On a second component 26 of the blocking arrangement 22 a transfer part 28 is fastened, which in turn is coupled to a belt buckle 32 by means of a steel cable 30 which is turned around. The blocking arrangement 22 and the transfer part 28 are guided in a housing part 34 which has an end stop 36 (only illustrated symbolically in FIG. 1). In a wall of the housing part 34, a detent arrangement 38 in the form of spaced recesses is formed. A locking pawl 40 of the blocking arrangement 22 can engage into the recesses. The detent arrangement 38 can also be constructed as locking teeth or the like, fixed to the vehicle or to a vehicle seat. The locking pawl 40 and the detent arrangement 38 are designed so that they can receive the forces occurring in a case of restraint.

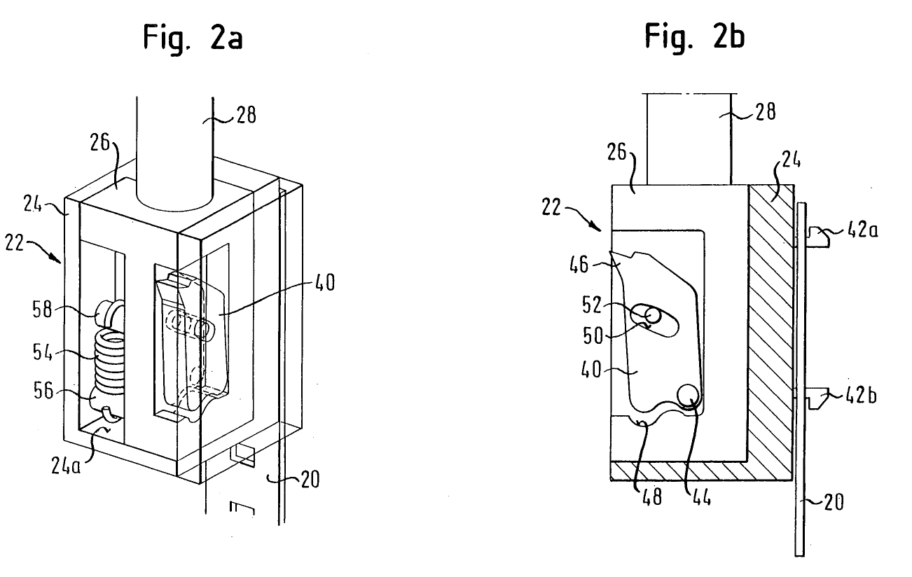

In FIGS. 2a and 2b, the blocking arrangement 22 of the belt buckle presenter is illustrated in detail. The first component 24 has two detent hooks 42a, 42b, which engage into the recesses of the conveyor belt 20, so that a force-fitting coupling of the first component 24 with the drive is formed. The second component 26, which is connected with the transfer part 28, rests on a base surface 24a of the first component 24 so that a force-fitting coupling with the belt buckle 32 is formed.

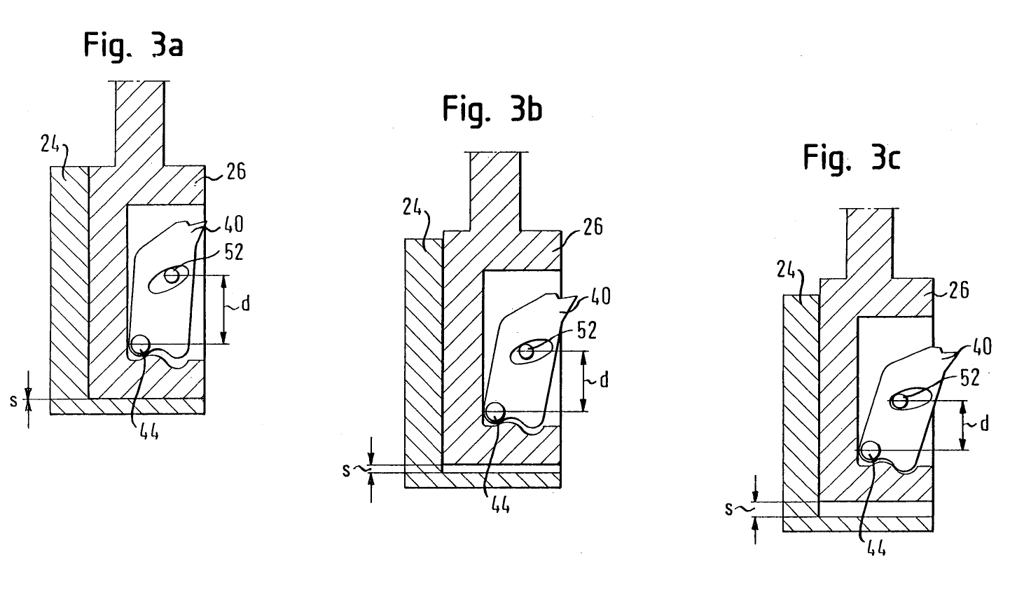

The locking pawl 40 is mounted by means of a bearing pin 44 in the second component 26 so that it can be swiveled from a release position about the axis of the bearing pin 44 into a blocking position, in which an extension 46 of the locking pawl 40 engages into the detent arrangement 38 of the wall of the housing part 34. A contour 48, matched to the shape of the pawl, in the base region of the second component 26 provides for a limiting of the swivel movement. The locking pawl 40 has a control structure 50, into which a control pin 52, coupled to the first component 24 (and hence to the drive), projects. The control structure 50 of the locking pawl 40 is shaped so that in the case of a moving apart of the two components 24 and 26, the control pin 52 causes a swiveling of the locking pawl 40 from the release position into the blocking position. The swivel position is shown in FIGS. 3a, 3b and 3c, from which it can be seen that an increase in the distance s between the two components 24 and 26 is equivalent to a reduction of the distance d between the bearing pin 44 and the control pin 52.

The blocking arrangement 22 has in addition a tension spring 54 (see FIG. 2a). One end of the tension spring 54 is suspended on a first pin 56, which is coupled to the first component 24, whilst the other end of the traction spring 54 is suspended on a second pin 58, which is coupled to the second component 26. The traction spring 54 is therefore a connecting member which holds the two components 24 and 26 together and only exceptionally permits a moving apart of the two components 24 and 26, namely when the elastic force of the spring 54 is overcome. In such a case, the locking pawl 40 is swiveled into the blocking position and engages into the detent arrangement 38, so that a movement of the belt buckle 32 is blocked.

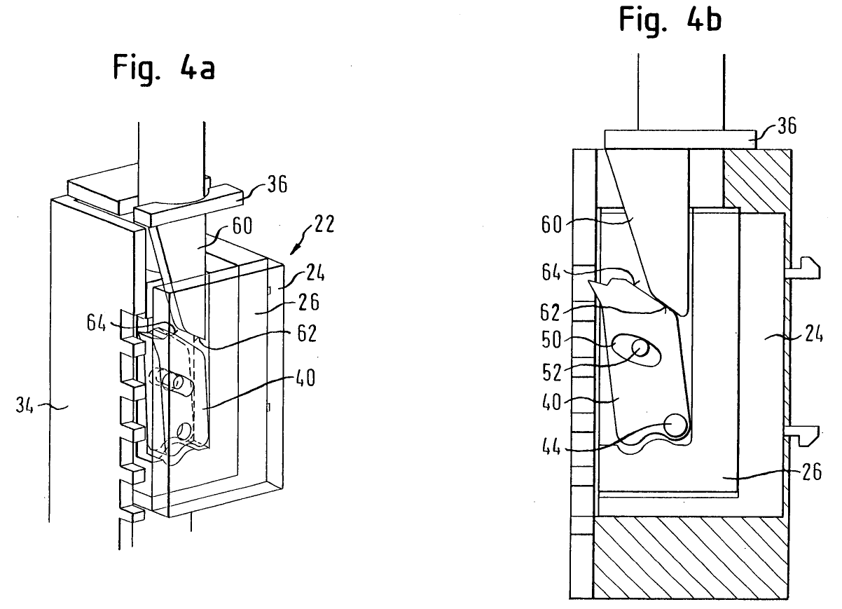

In FIGS. 4a and 4b, the end stop 36 for the blocking arrangement 22, provided on the end of the housing part 34 on the belt buckle side, is illustrated in further detail. The end stop 36 has a wedge 60 with a chamfered surface 62, which is matched to a likewise chamfered surface 64 of the locking pawl 40. If the blocking arrangement 22, after a contact of the two surfaces 62 and 64, moves further towards the end of the housing part 34 on the belt buckle side, the locking pawl 40 is moved relatively downwards until the control pin 52 stands against the upper edge of the control structure 50. The locking pawl 40 can then subsequently not shift further downwards. A movement of the locking pawl 40 downwards would only be possible if the control pin 52 allowed itself to move downwards. However, this is prevented owing to the force-fitting coupling of the control pin 52, to the drive which at this moment is moving upwards. Vice versa, the locking pawl 40 can neither move upwards, because such a movement is only possible as long as the end stop 36 does not engage on the locking pawl 40. Therefore, the wedge 62 of the end stop 36 exerts a force onto the locking pawl 40 which, owing to the positive guiding of the locking pawl 40, brings about a swiveling about the axis of the bearing pin 44 into the blocking position.

The mode of operation of the belt buckle presenter is described below. In the initial position shown in FIG. 1, in which the belt buckle 32 assumes a lower position in the vehicle, the two components 24 and 26 of the blocking arrangement 22 are spaced apart from each other, so that the locking pawl is swiveled into its blocking position and engages into the detent arrangement 38. Therefore, the belt buckle 32 in the initial position is secured against a drawing upwards at all times, independently of the tensile force acting on the belt buckle 32.

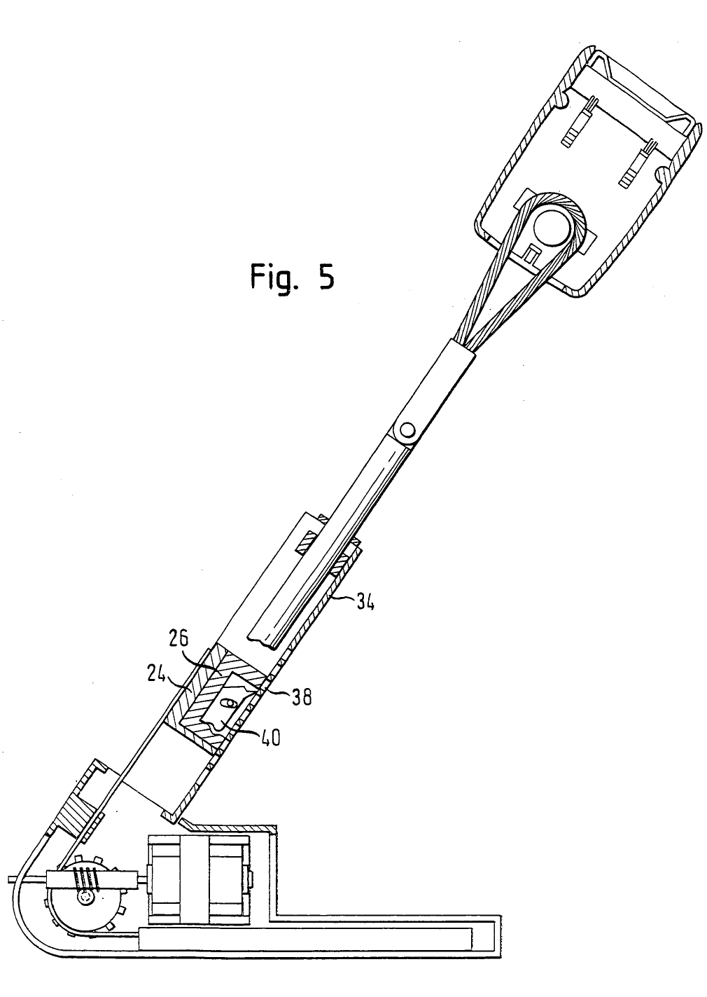

The blocking is then only discontinued when the electromotor 12 starts up and the first component 24, connected with the conveyor belt 20, is moved upwards towards the second component 26. The elimination of the relative distance between the two components 24 and 26 makes provision that the locking pawl 40 steers out and the blocking arrangement 22 with the transfer part 28 can be moved upwards. During acceleration (extension phase), the blocking arrangement 22 is deactivated (see FIG. 5).

Shortly before reaching the extension position in which the belt buckle 32 assumes an upper position for comfortable fastening, the surface 62 of the wedge 60 engages on the surface 64 of the locking pawl 40, so that the locking pawl 40, as described above and shown in FIG. 4b, is swiveled into the blocking position. Thereby, the belt buckle 32 is also secured against pulling in the extension position.

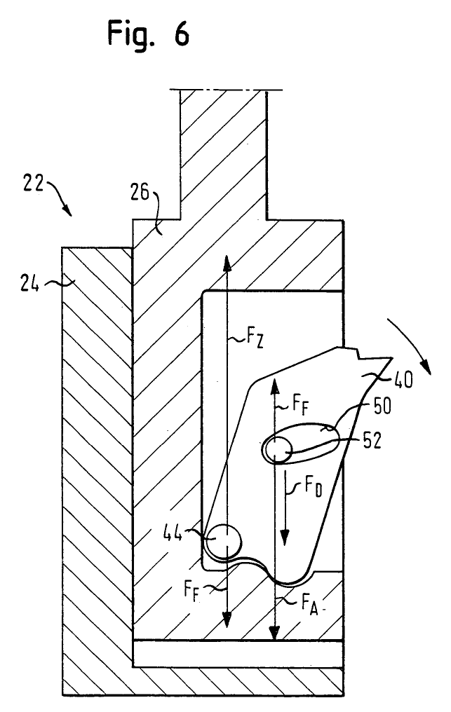

After fastening of the belt, the electromotor 12 is operated in an opposite direction of rotation, so that the belt buckle 32 is moved downwards again into the initial position. If a case of restraint occurs in this phase, an activation of the blocking arrangement 22 takes place, so that a movement of the belt buckle 32 upwards is prevented. The forces acting in this case on the blocking arrangement 22 are illustrated in FIG. 6.

The downwardly directed drive force F_{A} of the electromotor 12 acts on the first component 24 and hence also on the control pin 52, whilst the upwardly directed tensile force F_{Z} exerted by the occupant acts on the second component 26. If these forces exceed the elastic force F_{F} of the traction spring 54 acting between the two components 24 and 26, the two components 24 and 26 move apart. Taking into account all the above-mentioned forces, a downwardly directed differential force F_{D} is in fact produced onto the first component 24 and hence also onto the control pin 52. The control pin 52 transfers the differential force F_{D} to the locking pawl 40, so that owing to the rotatable bearing of the locking pawl 40, a torque acts on the locking pawl 40, which (with respect to the illustration of FIG. 6) causes a swiveling of the locking pawl 40 in a clockwise direction and hence a steering in of the locking pawl 40 into the detent arrangement 38.

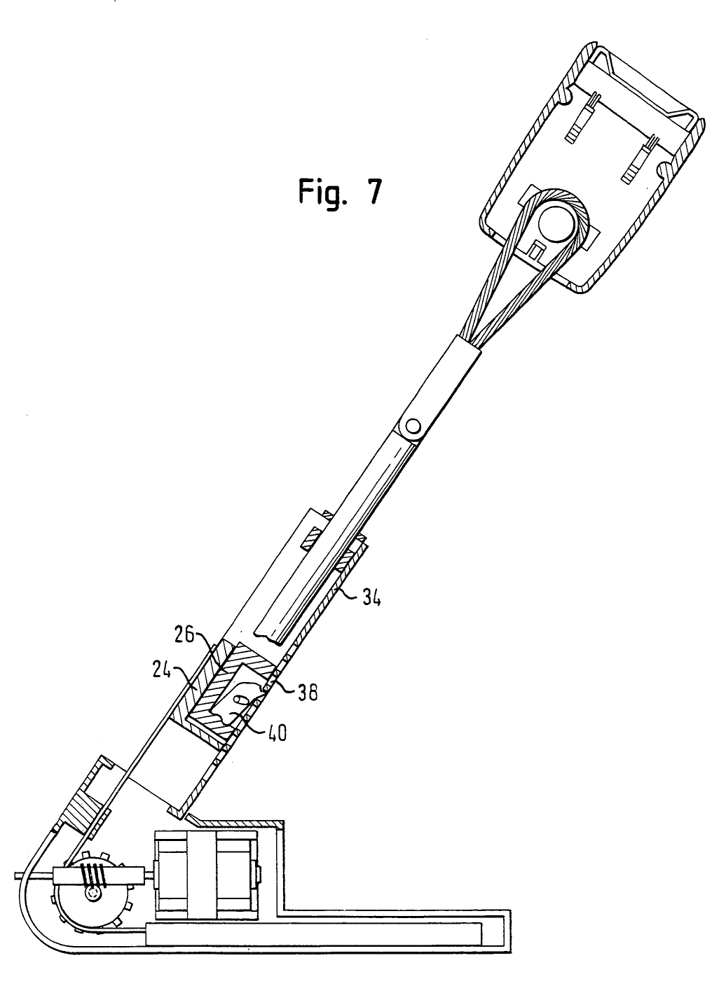

Therefore, in a case of restraint, an immediate blocking of the belt buckle in an intermediate position (between extension position and initial position) is ensured also in a phase in which the belt buckle 32 is moved downwards, as shown in FIG. 7. The tensile force F_{Z} at least necessary for an activation of the blocking arrangement 22 is determined by the elasticity constant of the tensile spring 54 and can be set as desired by a corresponding construction of the tensile spring 54.

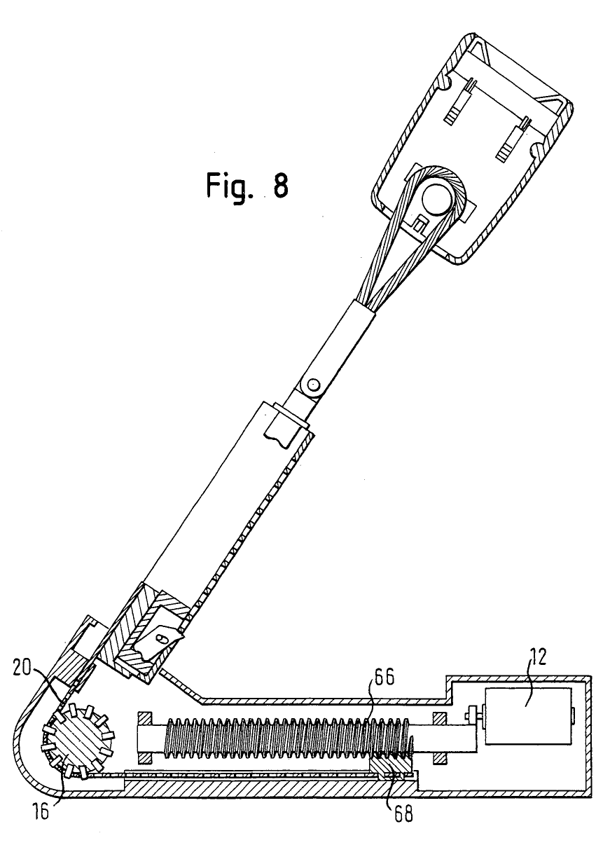

In FIG. 8 an alternative drive for the belt buckle presenter is illustrated. Here, the conveyor belt 20 is not driven by the roller 16, but rather by an elongated worm 66 coupled to the electromotor 12. For this, the worm 66 engages into corresponding recesses of a drive body 68 which is connected with the conveyor belt 20. This drive is distinguished by a very small width.

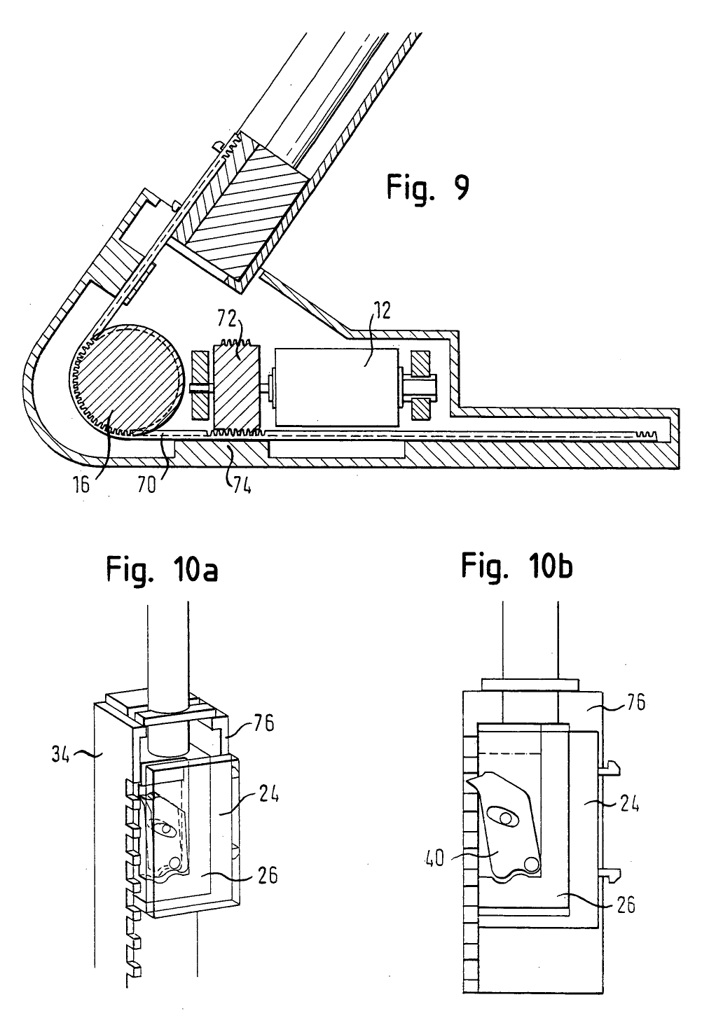

A further alternative drive for the belt buckle presenter is shown in FIG. 9. Instead of a conveyor belt with recesses, in this embodiment, a toothed belt 70 is provided, which is driven by means of a worm 72 coupled to the electromotor 12. A tolerance equalizing device 74 provides for an optimum contact of the toothed belt 70 with the worm 72. The roller 16 is grooved corresponding to the teeth of the toothed belt 70 and serves merely for the deflection of the toothed belt 70. This drive is distinguished by its simple and space-saving construction.

FIGS. 10a and 10b show an alternative end stop 76 of the belt buckle presenter. The end stop 76, securely connected with the housing part 34, is arranged opposite the first component 24 of the blocking arrangement 22, coupled to the drive. The end stop 76 does not have any influence on the second component 26 of the blocking arrangement 22 which is coupled to the belt buckle 32. The end stop 76 is constructed so that it can receive more force than the drive provides. When the first component 24 comes in abutment with the end stop 76 on acceleration of the belt buckle 32, the first component 24 is thus prevented from a further movement. If a tensile force F_{Z} now acts on the belt buckle 32, the second component 26 can only move further upwards. The second component 26 thereby moves away from the first component 24, with the result that the locking pawl 40, owing to its positive guidance, steers into the detent arrangement 38 and eliminates a movement of the belt buckle 32 in traction direction.

1. A belt buckle presenter capable of moving a belt buckle by means of a drive between a lower initial position and an upper extension position, the belt buckle presenter comprising a blocking arrangement, activation of the blocking arrangement in a case of restraint preventing the belt buckle from a movement upwards, the blocking arrangement also being able to be activated in an intermediate position between the initial position and the extension position.

2. The belt buckle presenter according to claim 1, wherein the blocking arrangement includes a blocking element movable between a release position, in which a movement of the belt buckle is enabled, and a blocking position, in which a movement of the belt buckle is blocked.

3. The belt buckle presenter according to claim 2, wherein the blocking element comprises a locking pawl which is able to engage into a detent arrangement fixed to the vehicle or a vehicle seat.

4. The belt buckle presenter according to claim 3, wherein the blocking arrangement includes a first component coupled to the drive and a second component coupled to the belt buckle.

5. The belt buckle presenter according to claim 4, wherein the blocking arrangement is activated by a relative movement of the first and second components.

6. The belt buckle presenter according to claim 5, wherein the locking pawl is mounted rotatably on a bearing pin coupled to the belt buckle, the locking pawl including a control structure into which a control pin engages, the control pin being coupled to the second component.

7. The belt buckle presenter according to claim 4, wherein the two components are held together by means of a connecting member, in particular by a tension spring.

8. The belt buckle presenter according to claim 1, wherein the drive comprises a roller and a conveyor belt, the roller being driven by an electromotor and having cams engaging into corresponding recesses of the conveyor belt.

9. The belt buckle presenter according to claim 1, wherein the drive comprises a worm and a conveyor belt, the worm being driven by an electromotor and, in turn, driving the conveyor belt by means of a drive body connected with the conveyor belt.

10. The belt buckle presenter according to claim 1, wherein the drive comprises a worm and a toothed belt, the worm being driven by an electromotor, the toothed belt being driven directly by the worm.

11. The belt buckle presenter according to claim 2, wherein an end stop is provided for the blocking arrangement, the blocking arrangement being activated upon reaching the end stop.

12. The belt buckle presenter according to claim 11, wherein the end stop engages directly on the blocking element.

13. The belt buckle presenter according to claim 4, wherein an end stop is provided for the blocking arrangement, the blocking arrangement being activated upon reaching the end stop.

14. The belt buckle presenter according to claim 13, wherein the end stop engages on the first component.
